(19) United States
(12) Patent Application Publication
(10) Pub. No.: US 2025/0115056 A1
(43) Pub. Date: Apr. 10, 2025

(54) Method and Processing Unit for Predicting a Servicing Situation

(71) Applicant: Canon Production Printing Holding B.V., Venlo (NL)

(72) Inventors: Claus Schneider, Eching (DE); Florian Hitzlsperger, Poing (DE); Christoph Rummelsberger, Ismaning (DE); Ulrich Stöckle, Germering (DE)

(21) Appl. No.: 18/906,398

(22) Filed: Oct. 4, 2024

(30) Foreign Application Priority Data
Oct. 6, 2023 (DE) 10 2023 127 229.2

(51) Int. Cl. B41J 2/21; B41J 2/165

(52) U.S. Cl. CPC B41J 2/2135; B41J 2/1652; B41J 2/16535; B41J 2/16579; B41J 2/2139; B41J 2/2142

(57) ABSTRACT

A processing unit is described for an inkjet printing device that is configured to predict the remaining duration until the presence of a servicing situation, on the basis of a chronological sequence of test print images from which the chronological development of the number of faulty nozzles emerges. The printing device can then be operated in an optimized manner under consideration of the predicted duration.

### CROSS-REFERENCE TO RELATED APPLICATION

This application claims priority to German Patent Application No. 10 2023 127 229.2 filed Oct. 6, 2023, the disclosure of which is hereby incorporated by reference in its entirety.

### BACKGROUND OF THE INVENTION

### Field of the Invention

The invention relates to a method and a corresponding processing unit that enable a precise prediction of a servicing situation of an inkjet printing device in order to increase the print quality and the operating efficiency of said printing device.

### Description of Related Art

An inkjet printing device for printing to a recording medium has at least one print bar with one or more print heads having respectively one or more nozzles. The nozzles are respectively configured to eject ink droplets in order to print dots of a print image onto the recording medium. The print bar and the recording medium are thereby moved relative to one another in order to print dots at different positions, in particular in different rows, on the recording medium, and in order to thus print a print image on the recording medium.

Due to various influences, failures of individual nozzles can occur over time, wherein individual failed nozzles can be compensated for at least in part via one or more compensation measures. The number of nozzle failures that can be compensated for is typically limited to a maximum allowable number of nozzle failures. Given the presence of a too high number of nozzle failures, a servicing of the inkjet printing device must therefore be performed in which, for example, a cleaning and/or a regeneration of the one or more print heads of the print bar takes place.

The interruption of a print job to perform the servicing of the print bar can lead to a negative effect on the printing efficiency and/or on the print quality of the inkjet printing device.

### SUMMARY OF THE INVENTION

The present document deals with the technical object of reliably increasing the printing efficiency and/or the print quality of an inkjet printing device given the presence of nozzle failures. The object is respectively achieved via the features of the device as described herein as well as via the features of the method as described herein.

According to one aspect, a processing unit is described for an inkjet printing device that comprises at least one print bar having a plurality of nozzles, wherein the plurality of nozzles is configured to print dots in a corresponding plurality of columns of a print image on a recording medium. The processing unit is configured to induce the print bar to print a corresponding sequence of test print images onto the recording medium at a sequence of successive points in time, and to respectively detect via sensors the test print images printed on the recording medium, in order to provide a sequence of detected test print images. The processing unit is also configured to predict, on the basis of the sequence of detected test print images, a remaining duration until a servicing situation in which a servicing of the print bar is to be performed, and to operate the printing device depending on the predicted remaining duration.

According to a further aspect, a method is described for operating an inkjet printing device that comprises at least one print bar having a plurality of nozzles, wherein the plurality of nozzles is configured to print dots in a corresponding plurality of columns of a print image onto a recording medium. The method comprises effecting that the print bar prints a corresponding sequence of test print images onto the recording medium at a sequence of successive points in time, and detecting the test print images printed onto the recording medium, in order to provide a sequence of detected test print images. The method also comprises predicting, on the basis of the sequence of detected test print images, a remaining duration until a servicing situation in which a servicing of the print bar is to be performed, and operating the printing device depending on the predicted remaining duration.

### BRIEF DESCRIPTION OF THE DRAWINGS

Exemplary embodiments of the invention are described in detail in the following using the schematic drawings. Thereby shown are:

FIG. 1 a block diagram of an example of an inkjet printing device;

FIG. 2a an example of a test print image;

FIG. 2b an example of a time curve of the number of failed nozzles; and

FIG. 3 a workflow diagram of an example of a method for operating a printing device.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

In the following description, numerous specific details are set forth in order to provide a thorough understanding of the embodiments of the present invention. However, it will be apparent to those skilled in the art that the embodiments, including structures, systems, and methods, may be practiced without these specific details. Well-known methods, procedures, components, and circuitry have not been described in detail to avoid unnecessarily obscuring embodiments of the invention. The connections shown in the figures between functional units or other elements can also be implemented as indirect connections, wherein a connection can be wireless or wired. Functional units can be implemented as hardware, software or a combination of hardware and software.

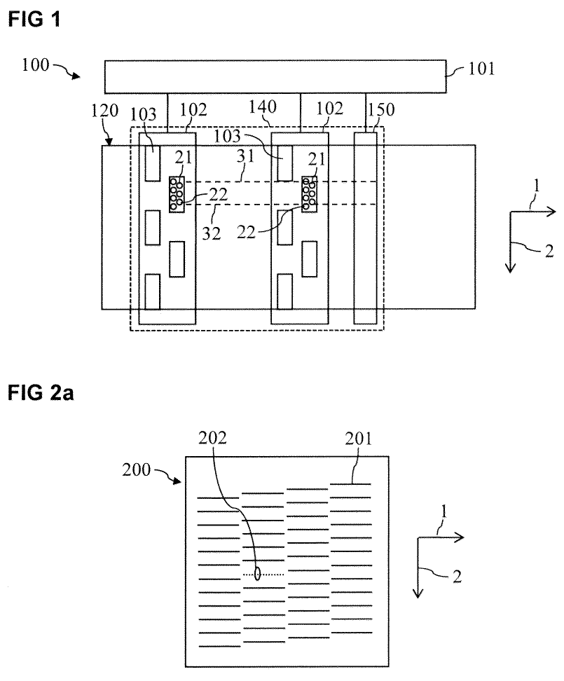

The printing device 100 depicted in FIG. 1 is designed for printing to a recording medium 120 in the form of a sheet or page or plate or belt. The recording medium 120 can be produced from paper, paperboard, cardboard, metal, plastic, textiles, a combination thereof, and/or other materials that are suitable and can be printed to. The recording medium 120 is directed through the print group 140 of the printing device 100 along the transport direction 1, represented by an arrow.

In the depicted example, the print group 140 of the printing device 100 comprises two print bars 102, wherein each print bar 102 can be used for printing with ink of a defined color, for example black, cyan, magenta, and/or yellow, and MICR ink if applicable. Different print bars 102 can be used for printing with respective different inks. Furthermore, the print group 140 can comprise at least one sensor unit 150, for example a camera, that is configured to acquire sensor data with regard to a print image printed on the recording medium 120.

A print bar 102 can comprise one or more print heads 103 that, if applicable, are arranged side by side in a plurality of rows in order to print the dots of different columns 31, 32 of a print image onto the recording medium 120. In the example depicted in FIG. 1, a print bar 102 comprises five print heads 103, wherein each print head 103 prints the dots of a group of columns 31, 32 of a print image onto the recording medium 120. The different columns 31, 32 of a print image are arranged side by side along the transverse direction. Furthermore, the individual columns 31, 32 respectively run along the transport direction 1.

In the embodiment depicted in FIG. 1, each print head 103 of the print group 140 comprises a plurality of nozzles 21, 22, wherein each nozzle 21, 22 is configured to fire or eject ink droplets toward the recording medium 120. A print head 103 of the print group 140 can, for example, comprise multiple thousands of effectively utilized nozzles 21, 22 that are arranged along a plurality of rows transverse to the transport direction 1 of the recording medium 120, i.e. along the transverse direction 2. Dots of a row of a print image can be printed onto the recording medium 120 transverse to the transport direction 1, i.e. along the width of the recording medium 120, by means of the nozzles 21, 22 of a print head 103 or of a print bar 102 of the print group 140.

The printing device 100 also comprises a control or processing unit 101, for example a driving hardware and/or a controller, that is configured to drive actuators of the individual nozzles 21, 22, of the individual print heads 103 of the print group 140 in order to apply a print image onto the recording medium 120 depending on print data. In an exemplary embodiment, the control or processing unit 101 includes processing circuitry or at least one processor that is configured to perform one or more functions and/or operations of the control or processing unit 101, including activating the actuators of the individual nozzles 21, 22 of the individual print heads 103 of the print group 140 to apply the print image onto the recording medium 120 based on print data, processing print and/or other data, control one or more modes of the printer device 100 and/or controlling one or more operations of the printing device 100. In an exemplary embodiment, the control or processing unit 101 includes one or more interfaces (e.g. a wired and/or wireless input and/or output interface, transceiver, or the like) that are configured to receive or output data or information. For example, the control or processing unit 101 may receive signals generated by one or more components of the printing device 100 (e.g. from a user interface of the printer device 100) and/or output control signals to one or more components of the printing device 100. In an exemplary embodiment, the control or processing unit 101 includes a memory configured to store data/information, and/or store executable code that is executable by the processing circuitry to cause the processing circuitry or at least one processor to perform the operation(s) of the control or processing unit 101.

As has been presented above, an impairment of individual nozzles 21, 22 of a print head 103 or of a print bar 102 can occur in the course of the operation of the printing device 100. In particular, total failures of individual nozzles 21, 22 can occur with time.

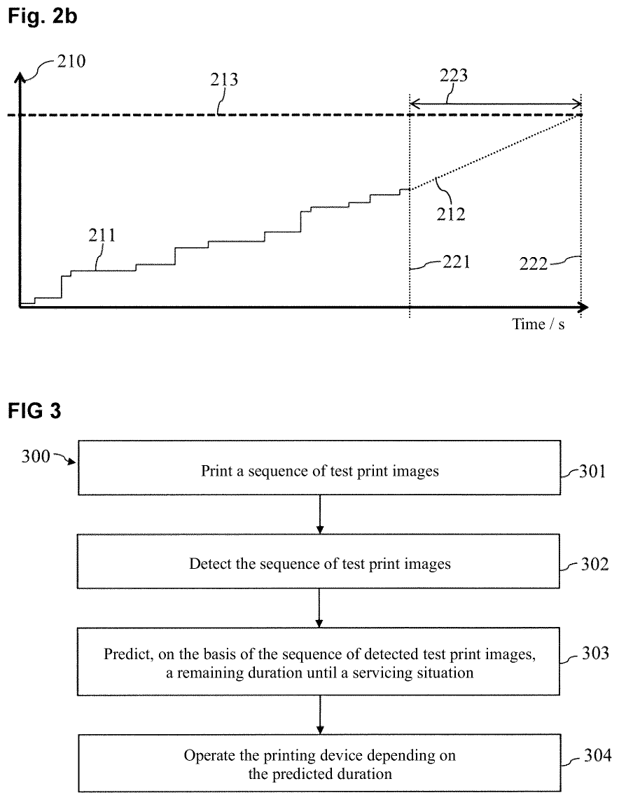

In order to determine the state of the individual nozzles 21, 22 of the printing device 100, a test print image 200 with a test pattern can be printed as is depicted by way of example in FIG. 2a. The test pattern can comprise individual lines 201, wherein each line 201 is respectively printed by exactly one single nozzle 21, 22. Every single nozzle 21, 22 of the printing device 100 can thus be induced to print precisely one line 201. The test print image 200 with the test pattern can be detected by the sensor unit 150.

For every single nozzle 21, 22, a check as to whether the respective nozzle 21, 22 is impaired or not can be made on the basis of the sensor data of the sensor unit 150, i.e. on the basis of the detected test print image 200. For example, it can be detected in particular that a defined line 202 is absent in the printed test print image 200. From this, it can be concluded that the nozzle 21, 22 corresponding to the defined line 202 has failed. Accordingly, the failure of a plurality of nozzles 21, 22 can be detected given the absence of a plurality of lines 202 in the detected test print image 200. The individual failed nozzles 21, 22 can also be identified.

The test print image 200 can be printed repeatedly, for example with a defined repetition rate. The number of failed nozzles 21, 22 can thus be respectively determined at a sequence of successive points in time. The individual nozzles 21, 22 that have failed can also be respectively identified.

The processing unit 101 of the printing device 100 can be configured to effect one or more compensation measures for the one or more failed nozzles 21, 22, in particular in order to reduce the impairment of the print quality due to the one or more failed nozzles 21, 22. For example, within the scope of a compensation measure for a failed nozzle 21, 22, a nozzle 21, 22 adjacent to the failed nozzle 21, 22 can be induced to close the gaps in the print image that were produced by the failed nozzle 21, 22, for example by increasing the ink quantity ejected by the adjacent nozzle 21, 22.

The effectiveness of the one or more compensation measures is typically linked to one or more boundary conditions. Examples of boundary conditions are
a condition to the effect that the total number of failed nozzles 21, 22 does not exceed a maximum permissible number of nozzle failures; and/or
a condition to the effect that the density of failed nozzles 21, 22 in different partial regions of the print bar 102, i.e. for different subsets of the nozzles 21, 22, does not exceed a maximum permissible failure density.

If the one or more boundary conditions for the effectiveness of the compensation measures are no longer satisfied, a servicing situation is typically entered in which the printing operation of the printing device 100 must be interrupted and in which a regeneration of the one or more print heads 103 of the print bar 102 must be performed. The nozzles 21, 22 of the one or more print heads 103 of a print bar 102 can be flushed with ink within the scope of the regeneration. The nozzle plates of the one or more print heads 103 can also be cleaned and/or wiped off.

The interruption of the printing operation during a running print job can lead to a negative effect on the printing efficiency and/or on the print quality of the printing device 100. The processing unit 101 of the printing device 100 can be configured to predict, on the basis of the analysis of a chronological sequence of test print images 200, a pending servicing situation of the printing device 100 in which the one or more boundary conditions for the effectiveness of the compensation measures are no longer satisfied. The pending servicing situation can already be predicted before the servicing situation has actually occurred. In particular, the remaining duration until the expected occurrence of a servicing situation can be predicted starting from a prediction point in time at which the prediction is performed.

The prediction of a pending servicing situation, and the predicted duration until the occurrence of the servicing situation, enable the operation of the printing device 100 to be controlled such that no servicing situation will occur during the printing of a print job, at least with a relatively high probability. The regeneration of the one or more print heads 103 of the print bar 102 can then be effected in a planned manner between two different print jobs. The print quality and the printing efficiency can thus be increased.

As is presented by way of example in FIG. 2b, the processing unit 101 can be configured to determine the respective number 210 of failed nozzles 21, 22 of the print bar 102 at the respective point in time on the basis of the individual test print images 200. A time curve 211 of the number 210 of failed nozzles 21, 22 can thus be determined on the basis of the sequence of test print images 200. The time curve 211 can, for example, be determined for a time period of one hour or more, or of 24 hours or more.

At a prediction point in time 221, the remaining time period 223, i.e. the remaining duration, until the number 210 of failed nozzles 21, 22 is expected to reach a defined numerical threshold 213, i.e. the maximum permissible number of nozzle failures, can be predicted on the basis of the measured time curve 211 of the number 210 of failed nozzles 21, 22. The point in time 222 at which it is expected that a servicing situation will be entered can thus be predicted. For this purpose, the measured time curve 211 of the number 210 of failed nozzles 21, 22 can be extrapolated in order to determine, starting from the prediction point in time 221, an extrapolated curve 212 of the number 210 of failed nozzles 21, 22. The point in time at which the extrapolated curve 212 reaches the numerical threshold 213 can be considered as an expected servicing point in time 222 at which the servicing situation is entered.

The number 210 of faulty nozzles 21, 22 can thus be monitored in that a test print image 200 is printed at the start of a page, integrated into a page, or on a separate page. The test print image 200 can be detected by sensors (for example, by a camera) and be evaluated by an algorithm, in particular in order to respectively determine the number 210 of faulty nozzles 21, 22.

By storing and monitoring the quantity of faulty nozzles 21, 22, the rise of the quantity, and if applicable the positions of the faulty nozzles 21, 22, a regression model can be created in order to analyze and extrapolate the tendency of the development of faulty nozzles 21, 22. The point in time 222 at which the limit 213 of the compensatable nozzle failures is reached can be predicted in advance with this algorithm. This enables the servicing process for regeneration of the print bar 102 to be planned better. For example, a print job can be completely ended, or a defined end point for the printing operation can be chosen. It can thus be avoided that incompletely printed print jobs must be printed again.

Since reaching the limit 213 of compensatable nozzle failures can be predicted, it can be effected that a critical value of nozzle failures that would negatively influence the print quality is not reached at all. The stop process and servicing process can be planned into the printing process so that the productivity of the printing device 100 is negatively affected as little as possible. Furthermore, the monitoring in the production planning can be improved.

A processing unit 101 for an inkjet printing device 100 is thus described that comprises at least one print bar 102 having a plurality of nozzles 21, 22. The plurality of nozzles 21, 22 is configured to print dots in a corresponding plurality of columns 31, 32 of a print image onto a recording medium 120.

The processing unit 101 is configured to induce the print bar 102 to print a corresponding sequence of test print images 200 onto a recording medium 120 at a sequence of successive points in time. The individual test print images 200 can respectively have a plurality of lines 201 for the corresponding plurality of nozzles 21, 22 in the corresponding plurality of different columns 31, 32.

The processing unit 101 is also configured to respectively sense, with the sensor unit 150 of the printing device 100, the test print images 200 printed onto the recording medium 120, in order to provide a sequence of detected test print images 200. The sequence of detected test print images 200 can then be analyzed, for example using a digital image analysis algorithm, in particular in order to detect one or more faulty, for instance failed, nozzles 21, 22, and/or in order to determine the increase of faulty nozzles 21, 22 over time. For this purpose, the processing unit 101 can be configured to detect that at least one of the plurality of lines 201 is absent in a detected test print image 200. Based on the detection, it can be determined that the nozzle 21, 22 corresponding to the missing line 202 is faulty. If applicable, a plurality of faulty nozzles 21, 22 can be detected and identified accordingly.

Furthermore, the processing unit 101 is configured to predict, on the basis of the sequence of detected test print images 200, the remaining duration 223 until the presence of a servicing situation in which a servicing of the print bar 102 is to be performed. A servicing situation can be present if, in particular as soon as, a predefined number and/or a predefined proportion of nozzles 21, 22 from the plurality of nozzles 21, 22 is faulty. Alternatively or additionally, a servicing situation can be present if, in particular as soon as, the one or more boundary conditions for the effectiveness of the one or more compensation measures to compensate for faulty nozzles 21, 22 are no longer satisfied.

The servicing of the print bar 102 can include the flushing of the plurality of nozzles 21, 22 with ink, and/or the cleaning and/or wiping of the nozzle plates of the one or more print heads 103 of the print bar 102.

How the quantity of faulty nozzles 21, 22 of the print bar 102 develops with time can be analyzed on the basis of the sequence of detected test print images 200. The remaining duration 223 until the presence of a servicing situation can be predicted based thereupon, wherein given the presence of a servicing situation the printing operation must be interrupted, typically immediately, for servicing of the print bar 102 as soon as it is detected that a servicing situation is present.

The processing unit 101 is also configured to operate the printing device 100 depending on the predicted remaining duration 223. In particular, a print job for the printing device 100 can thereby be selected depending on the predicted remaining duration 223 until the servicing situation, in particular such that a print job is selected that has a processing time up to the conclusion of the print job that is shorter than the predicted remaining duration 223. It can thus be ensured, with a relatively high probability, that the selected print job can be concluded before reaching the servicing situation. As a result of this, the printing efficiency and the print quality of the printing device 100 can be increased.

A processing unit 101 for an inkjet printing device 100 is thus described that is configured to predict the remaining duration 223 until the presence of a servicing situation on the basis of a chronological sequence of test print images 200 from which emerges the chronological development of the number 210 of faulty nozzles 21, 22. The printing device 100 can then be operated in an optimized manner under consideration of the predicted duration 223.

The processing unit 101 can be configured to effect, for the printing of a usable print image, for example within the scope of a print job, one or more compensation measures that are intended to reduce the effect of one or more faulty nozzles 21, 22 on the print quality of the usable print image. Furthermore, the processing unit 101 can be configured to suppress the one or more compensation measures for the printing of the individual test print images 200. Faulty nozzles 21, 22 can thus be particularly reliably detected on the basis of the individual test print images 200.

The processing unit 101 can be configured to determine, on the basis of the individually detected test print images 200 of the sequence of detected test print images 200, the respective number 210 of faulty nozzles 21, 22 at the respective point in time, in order to provide a time curve 211 of the number 210 of faulty nozzles 21, 22. The remaining duration 223 until the servicing situation can then be predicted on the basis of the time curve 211 of the number 210 of faulty nozzles 21, 22.

The processing unit 101 can in particular be configured to extrapolate the time curve 211 of the number 210 of faulty nozzles 21, 22 into the future, in particular using a regression method, in order to determine an extrapolated curve 212 of the number 210 of faulty nozzles 21, 22. The point in time 222 can also be determined at which the extrapolated curve 212 of the number 210 of faulty nozzles 21, 22 reaches and/or intersects a predefined numerical threshold 213. The numerical threshold 213 can thereby correspond to the maximum permissible number of faulty nozzles 21, 22.

The remaining duration 223 until the servicing situation can then be determined especially precisely and robustly on the basis of the determined point in time 222, in particular as the remaining duration until the determined point in time 222.

The processing unit 101 can be configured to determine, on the basis of the individually detected test print images 200 of the sequence of detected test print images 200, a respective error pattern of faulty nozzles 21, 22 within the plurality of nozzles 21, 22 of the print bar 102, in order to provide a chronological sequence of error patterns. The error pattern can then exhibit the two-dimensional structure of the arrangement of the plurality of nozzles 21, 22 of the print bar 102. Furthermore, the error pattern can indicate the one or more faulty nozzles 21, 22 within the arrangement of the plurality of nozzles 21, 22 of the print bar 102. The error pattern can thus indicate, in the form of a two-dimensional image, where the individual faulty nozzles 21, 22 are arranged within the arrangement of the plurality of nozzles 21, 22 of the print bar 102.

The remaining duration 223 until the servicing situation can then be predicted especially precisely on the basis of the chronological sequence of error patterns of faulty nozzles 21, 22. The individual error patterns can be graphically analyzed for this purpose. One or more reference error patterns can also be considered that respectively correspond to a servicing situation. The remaining duration until an error pattern will result that corresponds to a reference error pattern for a servicing situation can then be predicted on the basis of the chronological development of the error pattern.

The remaining duration until a servicing situation can be predicted especially precisely by taking into account the chronological development of the arrangement of the faulty nozzles 21, 22.

The processing unit 101 can be configured to determine, on the basis of the individually detected test print images 200 of the sequence of detected test print images 200, a respective spatial distribution of the density of faulty nozzles 21, 22 within the arrangement of nozzles 21, 22, in order to provide a chronological sequence of the spatial distribution of the density of faulty nozzles 21, 22. For a partial region or for a subset of nozzles 21, 22, the density can respectively indicate the proportion of faulty nozzles 21, 22 in the respective partial region or in the respective subset of nozzles 21, 22. For a plurality of different subsets or partial regions of nozzles 21, 22 from the plurality of nozzles 21, 22, a respective time curve of the density of faulty nozzles 21, 22 in the respective subset or in the respective partial region of nozzles 21, 22 can thus be determined on the basis of the chronological sequence of the spatial distribution of the density of faulty nozzles 21, 22.

The remaining duration 223 until the servicing situation can then be predicted particularly precisely on the basis of the chronological sequence of the spatial distribution of the density of faulty nozzles 21, 22. The processing unit 101 can in particular be configured to extrapolate into the future the plurality of time curves of the density of faulty nozzles 21, 22 in the corresponding plurality of subsets or partial regions of nozzles 21, 22. A point in time can also be determined at which a first, i.e. an earliest, of the plurality of extrapolated time curves of the density of faulty nozzles 21, 22 reaches and/or intersects a predefined density threshold. The remaining duration 223 until the servicing situation can then be determined especially precisely on the basis of the determined point in time, in particular as the remaining duration until the determined point in time.

According to a further aspect, an inkjet printing device 100 is described that comprises the processing unit 101 described in this document.

FIG. 3 shows a workflow diagram of an example of a method 300 for operating an inkjet printing device 100. The inkjet printing device 100 comprises at least one print bar 102 having a plurality of nozzles 21, 22. The nozzles 21, 22 of the print bar 102 can be arranged in one or more print heads 103. The plurality of nozzles 21, 22 can comprise 1000 or more nozzles 21, 22. The plurality of nozzles 21, 22 can be configured to print dots in a corresponding plurality of columns 31, 32 of a print image onto a recording medium 120. A respective one-to-one relation can thereby exist between the individual nozzles 21, 22 and the individual columns 31, 32, so that respectively precisely one column 31, 32 is associated with each nozzle 21, 22, and so that respectively precisely one nozzle 21, 22 is associated with each column 31, 32.

The method 300 comprises effecting 301 that the print bar 102 prints a corresponding sequence of test print images 200 onto the recording medium 120 at a sequence of successive points in time. For example, test print images 200 can be printed with a periodicity of 1 test print image 200 per Q pages of the recording medium 120, wherein Q≥1.

The method 300 also comprises detecting 302 the test print images 200 printed onto the recording medium 120 in order to provide a sequence of detected test print images 200. The individual test print images 200 can be detected using the sensor unit 150 of the printing device 100, which comprises a camera, for example.

Furthermore, the method 300 comprises predicting 303, on the basis of the sequence of detected test print images 200, a remaining duration 223 until a servicing situation in which a servicing of the print bar 102 is to be performed. For this purpose, the sequence of detected test print images 200 can be analyzed in order to determine the chronological development of faulty nozzles 21, 22. The remaining duration 223 until the servicing situation can then be predicted on the basis of the chronological development of faulty nozzles 21, 22.

The method 300 also comprises the operating 304 of the printing device 100 depending on the predicted remaining duration 223. In particular, one or more print jobs and/or the order of the print jobs that are processed by the printing device 100 can thereby be selected or set depending on the predicted remaining duration 223. The printing efficiency and the print quality of the printing device 100 can thus be increased.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the terms “processing circuitry” and “processing unit” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 transport direction
2 transverse direction
21, 22 nozzle
31, 32 column
100 printing device
101 control or processing unit
102 print bar
103 print head
120 recording medium
140 print group
150 sensor unit
200 test print image (test pattern)
201 printed line
202 missing line
210 number of faulty nozzles
211 measured time curve of the number of faulty nozzles
212 extrapolated time curve of the number of faulty nozzles
213 numerical threshold
221 prediction point in time
222 predicted servicing point in time
223 remaining duration until a servicing situation
300 method for operating an inkjet printing device
301-304 method steps

1. A processing unit for an inkjet printing device that comprises at least one print bar having a plurality of nozzles, wherein the plurality of nozzles is configured to print dots in a corresponding plurality of columns of a print image onto a recording medium, the processing unit comprising at least one processor configured to:
induce the print bar to print a corresponding sequence of test print images onto the recording medium at a sequence of successive points in time;
respectively detect via sensors the test print images printed on the recording medium, in order to provide a sequence of detected test print images;
predict, on the basis of the sequence of detected test print images, a remaining duration until a servicing situation in which a servicing of the print bar is to be performed; and
operate the printing device depending on the predicted remaining duration.

2. The processing unit according to claim 1, wherein the at least one processor is further configured to:
determine a respective number of faulty nozzles based on individually detected test print images of the sequence of detected test print images, in order to provide a time curve of the number of faulty nozzles; and
predict the remaining duration until the servicing situation based on the time curve of the number of faulty nozzles.

3. The processing unit according to claim 2, wherein the at least one processor is further configured to:
extrapolate into a future the time curve of the number of faulty nozzles in order to determine an extrapolated curve of the number of faulty nozzles;
determine a point in time at which the extrapolated curve of the number of faulty nozzles reaches and/or intersects a predefined numerical threshold; and
determine the remaining duration until the servicing situation based on the determined point in time.

4. The processing unit according to claim 1, wherein the at least one processor is further configured to: select a print job for the printing device depending on the predicted remaining duration until the servicing situation.

5. The processing unit according to claim 4, wherein the at least one processor is further configured to select the print job for the printing device such that a print job is selected that has a processing time until the conclusion of the print job that is shorter than the predicted remaining duration.

6. The processing unit according to claim 1, wherein
the test print image has a plurality of lines for the corresponding plurality of nozzles in the corresponding plurality of different columns; and
the at least one processor is further configured to:
detect that one of the plurality of lines is absent in the detected test print image; and
determine, based on the detection, that the nozzle corresponding to the missing line is faulty.

7. The processing unit according to claim 1, wherein the at least one processor is further configured to:
effect, for the printing of a usable print image, one or more compensation measures that are directed toward reducing an effect of a faulty nozzle on a print quality of the usable print image; and
suppress one or more compensation measures for the printing of a test print image.

8. The processing unit according to claim 1, wherein
the servicing situation is present if a predefined number and/or a predefined proportion of nozzles from the plurality of nozzles is faulty; and/or
the servicing situation of the print bar comprises a flushing of the plurality of nozzles with ink, and/or a cleaning and/or wiping of a nozzle plate of the print bar.

9. The processing unit according to claim 1, wherein the at least one processor is further configured to:
determine, based on the individually detected test print images of the sequence of detected test print images, a respective error pattern of faulty nozzles within the plurality of nozzles of the print bar, in order to provide a chronological sequence of error patterns; and
predict the remaining duration until the servicing situation based on the chronological sequence of error patterns of faulty nozzles.

10. The processing unit according to claim 1, wherein the at least one processor is further configured to:
determine, based on the individually detected test print images of the sequence of detected test print images, a respective spatial distribution of a density of faulty nozzles in order to provide a chronological sequence of the spatial distribution of the density of faulty nozzles; and
predict the remaining duration until the servicing situation based on the chronological sequence of the spatial distribution of the density of faulty nozzles.

11. A method for operating an inkjet printing device that comprises at least one print bar having a plurality of nozzles, wherein the plurality of nozzles is configured to print dots in a corresponding plurality of columns of a print image onto a recording medium, the method comprising:
inducing the print bar to print a corresponding sequence of test print images onto the recording medium at a sequence of successive points in time;
detecting the test print images printed onto the recording medium, in order to provide a sequence of detected test print images;
predicting, based on the sequence of detected test print images, a remaining duration until a servicing situation in which a servicing of the print bar is to be performed; and
operating the printing device depending on the predicted remaining duration.

12. The method according to claim 11, further comprising:
determining a respective number of faulty nozzles based on individually detected test print images of the sequence of detected test print images, in order to provide a time curve of the number of faulty nozzles; and
predicting the remaining duration until the servicing situation based on the time curve of the number of faulty nozzles.

13. The method according to claim 12, further comprising:
extrapolating into a future the time curve of the number of faulty nozzles in order to determine an extrapolated curve of the number of faulty nozzles;
determining a point in time at which the extrapolated curve of the number of faulty nozzles reaches and/or intersects a predefined numerical threshold; and
determining the remaining duration until the servicing situation based on the determined point in time.

14. The method according to claim 11, further comprising: selecting a print job for the printing device depending on the predicted remaining duration until the servicing situation.

15. The method according to claim 11, wherein
the test print image has a plurality of lines for the corresponding plurality of nozzles in the corresponding plurality of different columns; and
the method further comprises:
detecting that one of the plurality of lines is absent in the detected test print image; and
determining, based on the detection, that the nozzle corresponding to the missing line is faulty.

16. The method according to claim 11, further comprising:
effecting, for the printing of a usable print image, one or more compensation measures that are directed toward reducing an effect of a faulty nozzle on a print quality of the usable print image; and
suppressing one or more compensation measures for the printing of a test print image.

17. The method according to claim 11, further comprising:
determining, based on the individually detected test print images of the sequence of detected test print images, a respective error pattern of faulty nozzles within the plurality of nozzles of the print bar, in order to provide a chronological sequence of error patterns; and
predicting the remaining duration until the servicing situation based on the chronological sequence of error patterns of faulty nozzles.

18. The method according to claim 11, further comprising:
determining, based on the individually detected test print images of the sequence of detected test print images, a respective spatial distribution of a density of faulty nozzles in order to provide a chronological sequence of the spatial distribution of the density of faulty nozzles; and
predicting the remaining duration until the servicing situation based on the chronological sequence of the spatial distribution of the density of faulty nozzles.
